(19) United States
(12) Patent Application Publication
(10) Pub. No.: US 2025/0155848 A1
(43) Pub. Date: May 15, 2025

(54) WATERTIGHT WATCH CASE

(71) Applicant: Comadur SA, Le Locle (CH)

(72) Inventors: Valentin TKOCZ, Thulay (FR); Laurent BOURCET, Belfanys (FR)

(73) Assignee: Comadur SA, Le Locle (CH)

(21) Appl. No.: 18/809,479

(22) Filed: Aug. 20, 2024

(30) Foreign Application Priority Data
Nov. 15, 2023 (EP) 23210120.4

(51) Int. Cl. G04B 37/08; G04B 37/22

(52) U.S. Cl. CPC G04B 37/08; G04B 37/225

(57) ABSTRACT

A watertight watch case (1) including a middle (2), a back (3) and a sealing joint (4) disposed between the middle (2) and the back (3), the middle (2) and the back (3) being made of a ceramic material having a hardness greater than or equal to 1600 HV10, the middle (2) including a lower face (2a) and the back (3) including an upper face (3a), the lower and upper faces (2a, 3a) facing each other and serving as bearing surfaces for the sealing joint (4), the watertight watch case (1) wherein the lower and upper faces (2a, 3a) are formed by a set of concentric scratches (5). Also, a method for finishing the watertight watch case, which method comprises a satin-finishing step to obtain the set of concentric scratches (5).

### CROSS REFERENCE TO RELATED APPLICATION

This application claims priority to European Patent Application No. 23210120.4 filed Nov. 15, 2023, the entire contents of which are incorporated herein by reference.

### TECHNICAL FIELD OF THE INVENTION

The invention relates to a watertight watch case made from a ceramic material.

### TECHNOLOGICAL BACKGROUND

Watch cases are often made from a ceramic material which has the advantage of having a high hardness which guarantees its ability not to become scratched. For example, the prior art discloses a watertight watch case made from a ceramic material, and in particular from sintered zirconium oxide, which typically has an HV10 hardness of around 1200.

For watch cases that have to remain watertight at depths of several hundred metres, or even up to 600 metres, watertightness problems have been observed for ceramics with hardnesses greater than 1600 HV10, such as silicon nitride. After analysis, this loss of water-tightness was attributed to the difficulty of achieving a clean machining outcome for such hardnesses on the bearing surfaces of the joint sealing the middle and back of the case. These surfaces are typically machined on CNC machines using diamond grinding wheels. These wheels machine the surface by rotating about themselves at high speed. This rotational motion leaves machining scratches all over the machined surface. As shown diagrammatically in FIG. 1, these scratches 5 open onto the outside of the surface 2a, 3a and can, during use, form air entry points that compromise the watertightness of the case.

### SUMMARY OF THE INVENTION

The purpose of the present invention is to overcome this drawback by modifying the shape of the scratches so that they no longer open onto the outside of the surface. The invention consists in producing a satin finish, after machining, on the surfaces forming the sealing zone between the middle and the back in order to obtain a set of concentric scratches. These grooves are contained within the perimeter of the surface, which prevents air from entering. As the joint deforms, it matches the shape of the grooves. The fact that the grooves are in the same axis as the joint creates an air barrier, thus guaranteeing a watertight seal. On the other hand, when the grooves run transversely to the joint, the latter cannot deform sufficiently to fill all of the grooves. This leads to micro-passages for air and makes the joint leak at great depths.

More specifically, the present invention relates to a watertight watch case comprising a middle, a back and a sealing joint disposed between the middle and the back, the middle and the back being made of a ceramic material having a hardness greater than or equal to 1600 HV10, said middle comprising a lower face and the back comprising an upper face, said lower and upper faces facing each other and serving as bearing surfaces for said sealing joint, the watertight watch case being characterised in that said lower and upper faces are formed by a set of concentric scratches. According to the invention, said lower and upper faces include only, or are made up of, concentric scratches.

An optimum effect is obtained if the lower and upper faces have a given roughness. Thus, the arithmetic average of the roughness, referred to as the roughness Ra, of said lower and upper faces is between 0.1 and 0.8 μm in a direction which is perpendicular to the tangent at a point of the concentric scratches, said roughness Ra being measured according to standard ISO 4287, ASME B46.1—2019 over the entire width of the lower and upper faces in said direction.

Moreover, in the same direction over the entire width of the lower and upper faces, the maximum roughness, referred to as the roughness Rt, measured according to standard ISO 4287, ASME B46.1—2019 is between 1 and 5 μm.

The present invention further relates to the method for finishing said watertight watch case, which method comprises a step of satin-finishing the lower and upper faces to obtain the set of concentric scratches.

### BRIEF DESCRIPTION OF THE FIGURES

FIG. 1 diagrammatically shows a sealing zone of the watch case with scratches opening to the outside of the zone after machining, according to the prior art.

FIG. 2 shows the same sealing zone after satin-finishing according to the invention.

FIGS. 3a and 3b are observations under an optical microscope of the diagrammatic views shown in FIGS. 1 and 2 respectively.

FIGS. 4a and 4b show the directions in which the roughness measurements are taken.

FIG. 5 is a partial cross-sectional view of the watch case according to the invention.

### DETAILED DESCRIPTION OF THE INVENTION

The invention relates to a watertight watch case made from a ceramic material with a hardness greater than or equal to 1600 HV10, or even greater than or equal to 1800 HV10. The HV10 hardness is understood to mean a Vickers hardness measured in accordance with standard ISO 6507-1:2018. Preferably, the ceramic material is a silicon nitride (Si₃N₄). According to the invention, the watch case is able to remain watertight to a depth of 600 metres, regardless of the system for assembling the back to the middle, whether by screwing or otherwise.

The watch case 1 shown in a partial, cross-sectional view in FIG. 5, includes, in known manner, a middle 2 and a back 3 with a sealing joint 4 disposed between the middle and the back and intended to be compressed between a bearing surface 2a, also referred to as the lower face, of the middle 2 and a bearing surface 3a, also referred to as the upper face, of the back 3. In the example shown, the watch case is circular and the joint is an O-ring. According to the invention, the watch case can be of any shape (square, oblong, etc.) and the joint can be of any shape or material.

The middle 2 includes the lower face 2a and the back 3 includes the upper face 3a, the two faces 2a, 3a facing each other and serving as bearing surfaces for the joint 4 as mentioned above. Preferably, these bearing surfaces are flat. According to the invention, the lower face 2a and the upper face 3a have scratches 5 which do not open onto the outer perimeter of said faces. This prevents air or liquid from penetrating the case. More specifically, the scratches 5 visible in FIG. 2 form a set of concentric scratches around the central axis of the watch case. These scratches are similar in shape to the faces and the joint. Thus, if the latter are circular, the scratches are circular and concentric. If the faces are substantially rectangular, the scratches will be substantially rectangular and concentric, etc.

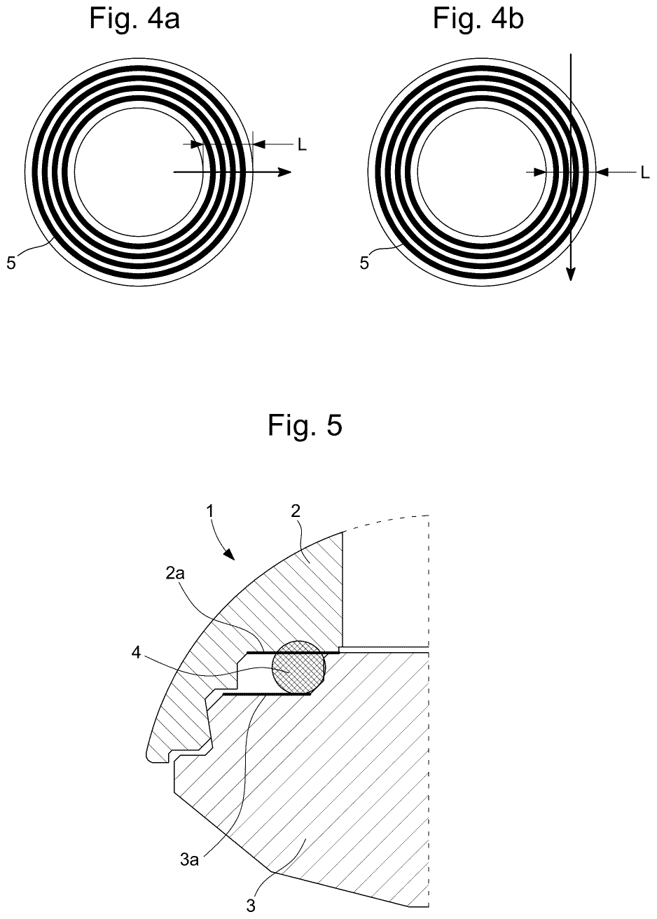

According to the invention, the surface finish is determined by the shape of the scratches and by the roughness of the surface including the scratches. For optimum effect, the arithmetic average roughness Ra measured in accordance with standard ISO 4287, ASME B46.1—2019 is between 0.1 and 0.8 μm in a direction perpendicular to the tangent at a point of the concentric scratches as shown in FIG. 4a over the entire width L of the lower and upper faces. In the same direction, the maximum roughness Rt measured according to the same standard is between 1 and 5 μm.

Advantageously, in another direction perpendicular to the aforementioned direction, with measurements taken halfway along the width L of the face, from and towards the outer perimeter of the face as shown in FIG. 4b, the arithmetic average roughness Ra is between 0.1 and 0.7 μm and the maximum roughness Rt is between 1 and 4 μm.

According to the present invention, scratches are produced by satin-finishing. Preferably, satin-finishing is carried out using diamond strips or grinding wheels. Another technology consists of producing a satin finish using a laser. Satin-finishing is carried out after machining the lower and upper faces of the middle and back respectively. The scratches can be of variable widths, and are typically less than a micron in width.

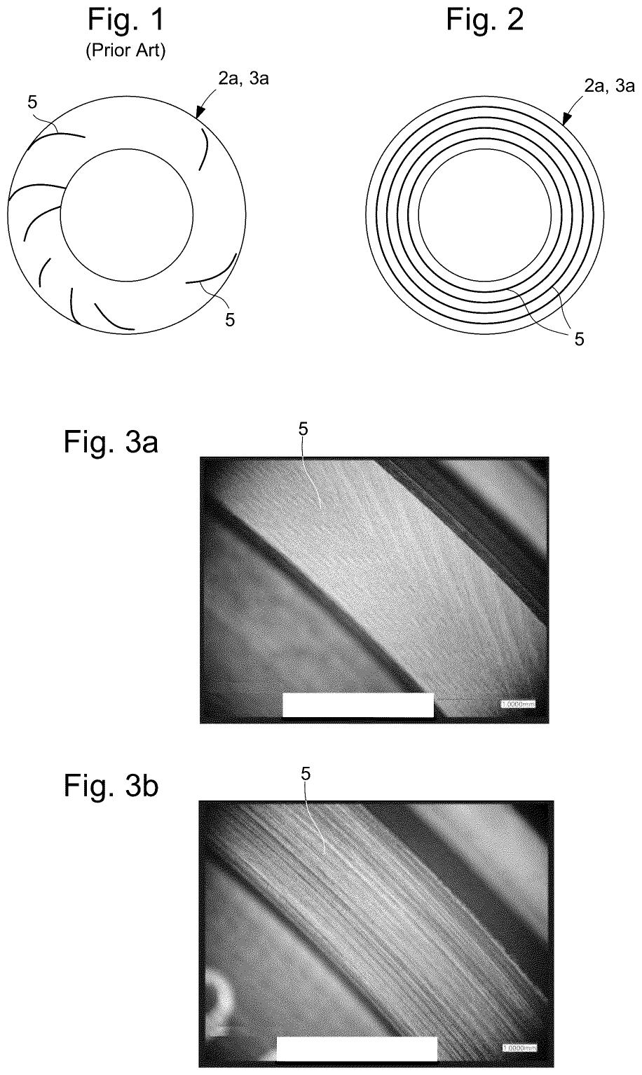

FIG. 3a shows the surface of one of the two faces after machining, without the satin finishing step according to the invention, whereas FIG. 3b shows the same surface after the satin finishing step. These results are shown in FIG. 1 and FIG. 2 respectively.

Regardless of the system used to assemble the middle and the back, optimum water-tightness to a depth of 600 metres is ensured thanks to the concentric grooves in the sealing zone between the middle and the back.

1. A watertight watch case (1) comprising a middle (2), a back (3) and a sealing joint (4) disposed between the middle (2) and the back (3), the middle (2) and the back (3) being made of a ceramic material having a hardness greater than or equal to 1600 HV10, said middle (2) comprising a lower face (2a) and the back (3) comprising an upper face (3a), said lower and upper faces (2a, 3a) facing each other and serving as bearing surfaces for said sealing joint (4), the watertight watch case (1), wherein said lower and upper faces (2a, 3a) are formed by a set of concentric scratches (5).

2. The watertight watch case (1) according to claim 1, wherein the arithmetic average of the roughness, referred to as the roughness Ra, of said lower and upper faces (2a, 3a) is between 0.1 and 0.8 μm in a direction which is perpendicular to the tangent at a point of the concentric scratches (5), said roughness Ra being measured according to standard ISO 4287, ASME B46.1—2019 over the entire width (L) of the lower face (2a) and upper face (3a) in said direction.

3. The watertight watch case (1) according to claim 2, wherein, in said direction over the entire width (L) of the lower face (2a) and upper face (3a), the maximum roughness, referred to as the roughness Rt, measured according to standard ISO 4287, ASME B46.1—2019 is between 1 and 5 μm.

4. The watertight watch case (1) according to claim 2, wherein in a direction perpendicular to said direction, passing entirely through said lower face (2a) and upper face (3a), halfway along the width (L) thereof, the roughness Ra is between 0.1 and 0.7 μm and the roughness Rt is between 1 and 4 μm.

5. The watertight watch case (1) according to claim 1, wherein the hardness is greater than or equal to 1800 HV10.

6. The watertight watch case (1) according to claim 1, wherein the ceramic material is silicon nitride.

7. The watertight watch case (1) according to claim 1, wherein the lower face (2a) and upper face (3a) are flat.

8. The watertight watch case (1) according to claim 1, wherein the watch case is capable of remaining watertight up to a depth of 600 metres.

9. A method for finishing the watertight watch case (1) according to claim 1, wherein the method includes a step of satin-finishing said lower face (2a) and upper face (3a) to obtain the set of concentric scratches (5).

10. A method for finishing the watertight watch case (1) according to claim 1, wherein the satin-finishing step is carried out using diamond strips or grinding wheels.
